(19) United States
(12) Patent Application Publication
(10) Pub. No.: US 2012/0234852 A1
(43) Pub. Date: Sep. 20, 2012

(54) AUTOMATED STORAGE AND DISPENSING SYSTEM

(76) Inventors: Peter George Guthrie, Loganville, GA (US); George W. Guthrie, West Melbourne, FL (US)

(21) Appl. No.: 13/050,226

(22) Filed: Mar. 17, 2011

(51) Int. Cl. B65D 83/00; B65G 59/00

(52) U.S. Cl. 221/1; 221/123; 221/119

(57) ABSTRACT

A storage and dispensing system including a cabinet having a frame with a plurality of separators, each separator including an opening formed therethrough. The system further includes a plurality of drawers, each drawer having a plurality of compartments configured to store an item therein. Each drawer is positioned adjacent to at least one of the separators and is movable relative to the adjacent separator such that each compartment of each drawer is positionable adjacent to the opening of the associated separator.

The present invention is directed to a system for storing and dispensing items, and more particularly, to a system for automatically storing and dispensing items.

### BACKGROUND

Distribution centers, warehouses, and the like are typically used to store items in inventory such that the items can be retained and pulled on demand. In a typical warehouse, items are stored and await shipment to a customer, to other warehouses/plants, or to other locations within the same warehouse/plant. Shipment of an item might involve only that item, or a combination of that item with one or more other items. Due to the vast number of items in inventory and their varying storage locations, the storage of items in inventory and the compilation/assembly of items for shipment can be a complicated operation, especially if it is to be done on a cost effective basis.

In traditional manually operated inventory systems, each particular item would be stored in a dedicated warehouse location, storage bin, tray, rack, pallet, or the like, which is generally referred to as a “pick face.” In order to inventory/store an item, a worker would first have to determine the appropriate storage location for the item, deliver the item to the storage location, verify the identification and quantity of the item, and then place the item in the storage location. Conversely, in order to fill an order/request, a worker would receive a pick slip/packing slip listing all of the items required to fill a particular order/request, which could be in printed or electronic form. The worker would then travel to a pick face, identify the item and quantity, retrieve the item in the appropriate quantity, and then travel to the next pick face to collect an item or items, all while cross-checking the order on the pick slip/packing slip.

### SUMMARY

In one embodiment the present invention is an improved system for storing and accessing items stored in inventory. More particularly, in one embodiment the invention is a storage and dispensing system including a cabinet having a frame with a plurality of separators, each separator including an opening formed therethrough. The system further includes a plurality of drawers, each drawer having a plurality of compartments configured to store an item therein. Each drawer is positioned adjacent to at least one of the separators and is movable relative to the adjacent separator such that each compartment of each drawer is positionable adjacent to the opening of the associated separator.

### BRIEF DESCRIPTION OF DRAWINGS

FIG. 1 is a top perspective view of one embodiment of the system of the present invention, shown as a cabinet with the outer wall of the cabinet being transparent to enable viewing of the internal components thereof;

FIG. 2 is a front perspective view of a drawer of the system of FIG. 1;

FIG. 3 is a front perspective view of a guide of the system of FIG. 1;

FIG. 4 is a top perspective view of a drawer of the system of FIG. 1, with the associated guide in a first rotational position;

FIG. 5 is a top perspective view of the drawer and guide of FIG. 4, with the guide in a second rotational position;

FIG. 6 is a top perspective view of the drawer and guide FIG. 5, shown in a different translational position;

FIG. 7 is a bottom perspective view of the drawer and guide of FIG. 6, showing an item exiting the drawer;

FIG. 8 is a bottom perspective view of a shutter, shown in its retracted position; and

FIG. 9 is a schematic representation of an inventory system.

### DETAILED DESCRIPTION

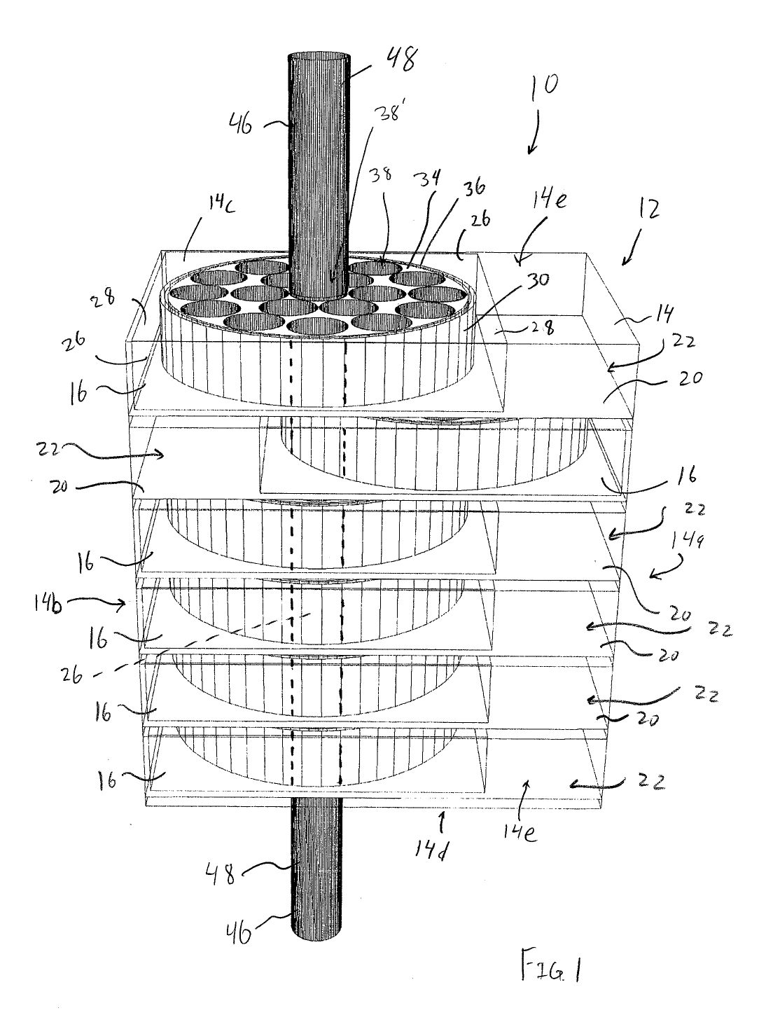

As best shown in FIG. 1, in one embodiment the system of the present invention is a storage and dispensing system, generally designated 10, including a cabinet 12 with a frame or body 14 and a plurality of drawers 16 and guides 34 contained therein. In the illustrated embodiment, the frame 14 includes a front panel 14a, back panel 14b, top panel 14c, bottom panel 14d and side panels 14e substantially surrounding and enclosing the cabinet 12. If desired, the panels 14a, 14b, 14c, 14d, 14e, or parts thereof, can be transparent to enable viewing of the interior of the cabinet 12, or be opaque for security or other purposes, or be combinations of transparent and opaque. Moreover, if desired, the panels 14a, 14b, 14c, 14d, 14e may have access openings (not shown) at strategic locations to provide access to the items 18 stored therein and/or parts of the cabinet 12, to enable repair, maintenance and the like. The illustrated cabinet 12 is generally shaped as a rectangular prism, although the cabinet 12 can take any of a wide variety of shapes and configurations beyond those specifically shown in FIG. 1.

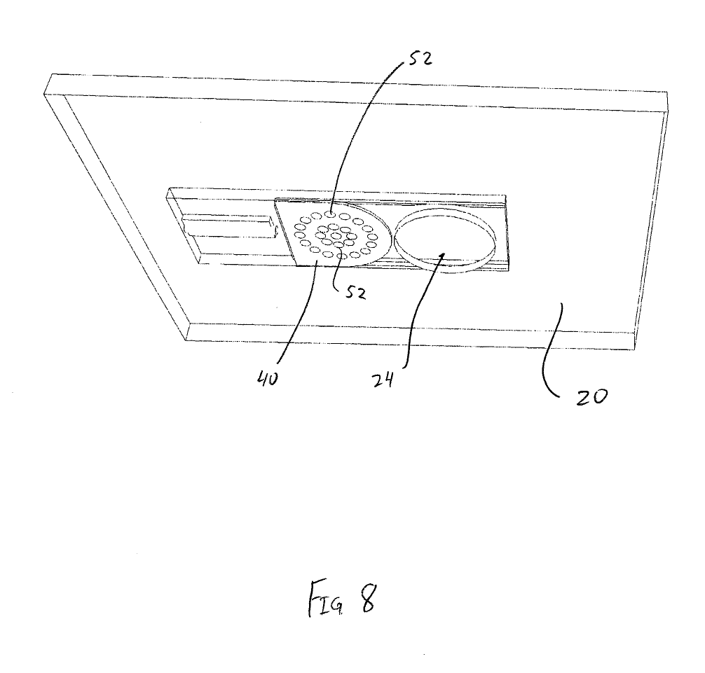

The cabinet 12/frame 14 includes a plurality of generally flat, planar horizontally-extending separators or separator plates 20 which divide the cabinet 12/frame 14 into a plurality of slots 22. The cabinet 12 can include any of a desired number of slots 22, such as between one and thirty in one case, but may include at least two slots 22, although six slots 22 are shown in the illustrated embodiment. Each separator plate 20 includes an opening 24 formed therein (see FIG. 8). In the illustrated embodiment, each opening 24 is located near the center of the associated separator plate 24, and each opening 24 of each plate 22 is vertically aligned with the other openings 20 to define a transfer duct 26 (FIG. 1).

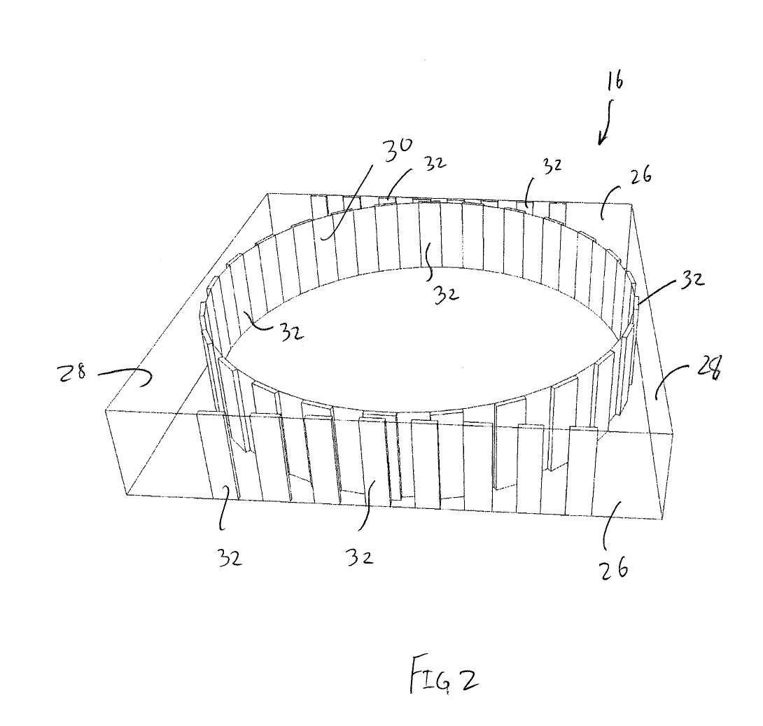

The system 10/cabinet 12 further includes a plurality of drawers 16, one of which is shown in FIG. 2. Each drawer 16 is slidably received in an associated slot 22 and thereby supported by an underlying separator plate 20. In the illustrated embodiment, each drawer 16 includes a pair of opposed, generally vertically extending sidewalls 26, a pair of opposed end walls 28, and a generally cylindrical guide wall 30. However, as can be appreciated, each drawer 16 may have any of a variety of shapes besides the illustrated square/rectangular shape as desired, including triangular, hexagonal, circular, etc. The drawer 16 may be hollow or open in its center portion defined by the guide wall 30. Each side wall 26 and the guide wall 30 includes a set of magnets or electro-magnets 32 coupled thereto along their lengths. The drawers 16 may be generally modular such that they are easily replaced should a drawer 16 become damaged or need to be removed for repair or maintenance.

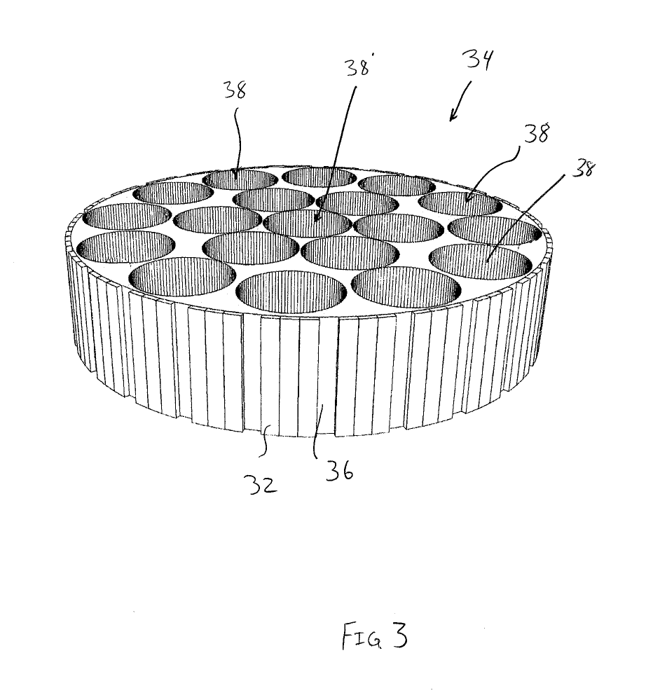

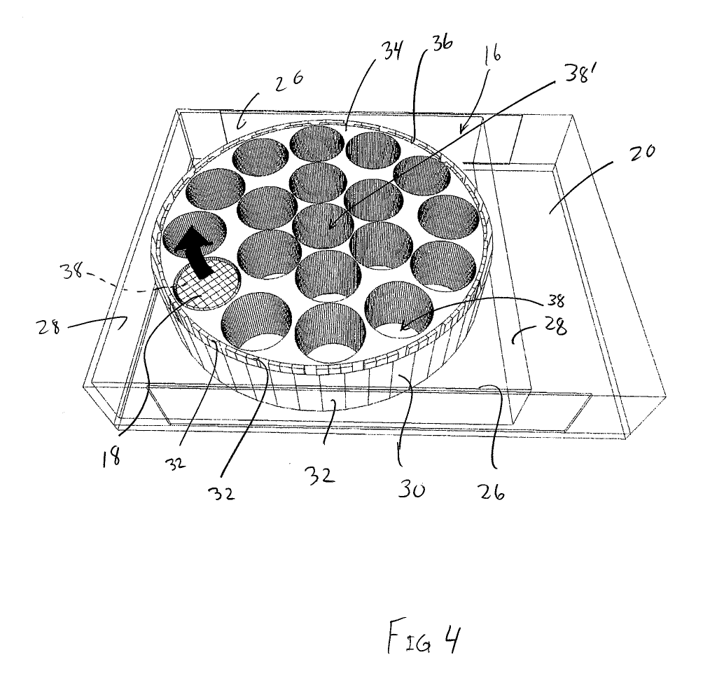

The system 10 includes a plurality of guides 34, one of which is shown in FIG. 3, which are shaped and configured to be closely received in the guide wall 30 of a drawer 16. Each guide 34 is generally disk-shaped and includes a generally cylindrical outer wall 36 concentric with, and positioned adjacent to, the associated guide wall 30 when positioned therein (see FIG. 4). A plurality of magnets or electro-magnets 32 extend around each outer wall 36. Each guide 34 includes a plurality of compartments/cells 38 formed, and each compartment 38 is sized and shaped to store an item 18 therein (FIG. 4). Each compartment 38 may have a height roughly equal to the height of the associated slot 22 such that the separator plates 20 and guides 34 cooperate to form generally closed compartments 38. In the illustrated embodiment each compartment 38 is defined by solid walls. However, the compartments 38 can be defined by perforated or other materials, such as wire mesh or the like to provide materials saving and cost reduction. In particular, each guide 34 may be slidable along ball bearings or the like (not shown) disposed between the guide 34 and separator plate 20 to direct the lateral and rotational movement of the guide.

In the illustrated embodiment, each compartment 38 is generally cylindrical, and the compartments 38 are arranged in concentric patterns of rings of compartments 38. However, the compartments 38 can take any of a wide variety of shapes beyond those specifically shown and described herein and be sized to receive various types of items therein. For example, rather than being circular in cross section, each compartment 38 can be elliptical, oval, hexagonal or other shapes in cross section. In addition, although the compartments 38 are illustrated as having uniform size and shape, the size and shape of the compartments 38 in various guides 34, or even in the same guide 34, can vary as desired to accommodate different items to be stored therein. In addition, the arrangement of compartments 38 can vary depending upon the shape and configuration of the guide 34 and the size and shape of the compartments 38. Thus, the compartments 38 may not necessarily be arranged in any particular pattern, but may instead generally be arranged to maximize spacing efficiency.

Each guide 34 may include a central opening 38′. In the illustrated embodiment, the central opening 38′ has the same size and configuration as the other compartments 38. However, the central opening 38′ need not necessarily have the same size and configuration as the other opening 38. Each central opening 38′ should be, in one case, at least about as large (in cross sectional area) as the opening 24 of the separator plates 20.

As shown in FIG. 4, each drawer 16 or base portion includes, or receives, a guide 34 therein, positioned in the guide wall 30 such that the guide 34 rests on an underlying separator plate 20. Each drawer 16 is laterally displaceable relative to the frame 14 and underlying separating plate 20. In particular, each drawer 16 may be slidable along ball bearings or the like (not shown) disposed between the drawer 16 and the separator plate 20 to guide the lateral movement of the drawer 16. In the embodiment shown in FIG. 2, each drawer 16 includes a plurality of magnets or electro-magnets 32 on its sidewalls 26. The side panels 14e of the frame 14 also have a plurality of magnets or electro-magnets (not shown) that are positioned adjacent to the electro-magnets 32 of an associated drawer 16. In this manner, a current can be passed through one or both of the sets of electro-magnets to cause drawers 16 to be laterally displaced as desired. Electrical current can be passed through a wiring harness or solid state circuitry that is positioned within the slots 22 to activate electro-magnets 32. However, each drawer 16 can be laterally displaced by any of a wide variety of mechanisms or means besides electromagnetic forces, such as by electric motors, lineal actuators, pneumatic forces, a linear synchronous motor (“LSM”) (such as a LSM sold by MagneMotion of Devens, Mass.), etc.

The guide 34 of each drawer 16 is rotatable relative to the rest of the drawer 16, the frame 14 and/or separator plates 20. In particular, each guide 34 may be rotatable about its center and can be mounted on ball bearings or the like (not shown) to guide its rotation. In the illustrated embodiment, the magnets/electro-magnets 32 of the guide 34 interact with the magnets/electro-magnets 32 of the guide wall 30. Electrical current can be passed through a wiring harness or solid state circuitry that is positioned within the drawer 16 to activate electro-magnets 32. In particular, one or both sets of magnets/electro-magnets 32 can be actuated to cause rotation of the guide 34 in either direction about its center. Of course, the guide 34 can be rotated by any of a wide variety of other mechanisms or means, including the mechanisms/means described above in the context of sliding motion of the drawers 16. Additionally, the sets of magnets/electro-magnets 32 can be actuated to cause rotation as well as the lateral movement of the guide 34.

In the illustrated embodiment, the entire guide 34 is rotated such that each item 18/compartment 38 in the guide 34 is rotated together. However, if desired, various parts of the guide 34 can be individually rotated. For example, if desired, the guide 34 may include a plurality of concentric rings, each which is independently rotatable relative to any adjacent rings.

In this manner, by rotational movement of the guides 34 and lateral movement of the drawers 16, each of the compartments 38 (and any item 18 stored therein) is movable relative to the opening 24 of the associated separator plate 20. However, besides being rotatable, the guide 34 could also be laterally and/or longitudinally displaceable relative to the drawer 16. Moreover, in the illustrated embodiment, each drawer 16 is laterally displaceable in two opposite directions (i.e., left-to-right in FIG. 1). If desired, however, the drawer 16 may also be configured to be movable in at least two opposite, perpendicular directions in the same plane. Moreover, the drawer 16 itself may be rotatable relative to the frame 12/associated separator plate 20.

Each compartment 38 is sized and configured to receive an item therein. The items 18 may be uncontained, or can be stored in packaging or the like. The use of containers may provide a known and smooth outer shape to an item which can improve ease of handling. However, use of a container in this manner can take up additional space and require additional handling since items are required to be placed into, and removed from, the containers.

In some cases, each compartment 38 is sized to have a footprint no larger than about 10%, or about 50%, of the footprint of an item 18 received therein such that each compartment 38 closely receives the item 18 therein. However, it should be noted that each compartment 38 may be configured to only constrain or cause movement of an item in the lateral/horizontal direction, and not the vertical/axial direction. In particular, each compartment 38 may lack any top and/or bottom wall to allow an item 18 to be passed into, and removed from, a compartment 38 in either vertical direction. In this case, then, when the guide 34, within the drawer 16 is received on a separator plate 20, an item 18 received in a compartment 38 may in fact rest upon the separator plate 20, but be constrained from significant horizontal movement by the guide 34. Thus, when the guide 34 is rotated, the walls of the compartment 38 engage an item 18 received therein and cause corresponding movement of the items 18 stored therein.

As shown in FIG. 8, each separator plate 20/opening 24 may include an associated retractable shutter 40 or similar mechanism which can be moved between a closed or extended position, wherein the shutter 40 generally blocks the opening 24 sufficient to prevent items 18 from passing therethrough, and a retracted or open position (shown in FIG. 8), wherein the shutter 40 is retracted sufficiently to allow items 18 to pass through the associated opening 24. Each shutter 40 or similar mechanism can be laterally displaced by any of a wide variety of mechanisms or means besides electromagnetic forces, such as by electric motors, lineal actuators, and pneumatic forces. Electrical current can be passed through a wiring harness or solid state circuitry that is positioned within the separator plat 20 to activate the shutter 40.

The shutters 40 (or similar mechanisms), when closed, allow the drawers 16 to be freely moved across the associated separator plates 20 without any items stored in a compartment 38 falling through the openings 24. Alternately, however, if desired the shutters 40 can be omitted, and the system 10 may instead include unoccupied compartments 38 in the guide 34. The always-unoccupied compartments 38 can be tracked by the system 10 to allow the drawer 16 to be moved in such a manner to avoid dropping any undesired items through the opening 24.

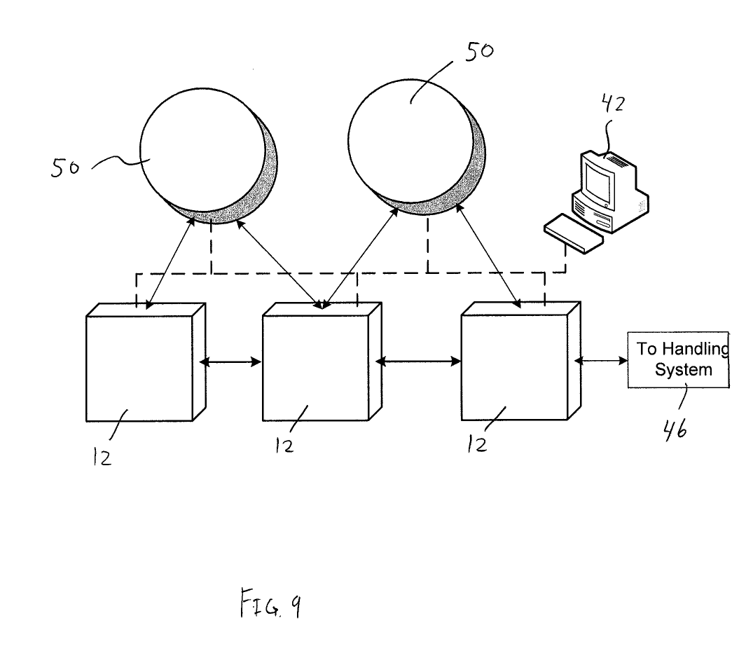

A controller 42, such as a processor, computer, CPU, or the like (collectively termed a controller 42 herein, FIG. 9) may be operatively coupled to the cabinet 12. The controller 42 may be programmed, or execute software, to control the system 10. In particular, the controller 42 can control the lateral or other displacement of each drawer 16, rotational or other movement of the guide 34, and activation of the shutters 40. The controller 42 may include or be operatively coupled to a database which stores and tracks the identity and qualities of each item 18 stored in each compartment 38. The lateral position of each drawer 16 and rotational position of each guide 34 may also be stored and tracked by the controller 42, possibly through the use of feedback and/or sensors. The controller 42 may also be configured to track which compartments 38 are empty.

In order to retrieve an item 18 from the cabinet 12, the controller 42 may first receive a request for a particular item or items. The request can come from a variety of senders, such as the operator of a warehouse, a customer, a shipping company, another controller/computer, etc. The item request can take any of a wide variety of forms including identifying an item by name, stock-keeping unit (“SKU”), description, part number, qualities of the item, identity as part of a requested part kit, etc. Once the controller 42 receives a request for an item 18, the controller 42 identifies the appropriate location of the item 18. If the system 42/cabinet 12 has more than one of the identified items 18, the controller 42 may determine which particular item 18 is to be retrieved if the request does not itself specify any one particular item. For example, the controller 42 may have an algorithm programmed therein or accessible thereby to determine which particular item 18 is to be retrieved. The controller 42 may be programmed to retrieve an item 18, for example, based upon its age, or its storage time, or by following certain inventory protocols (such as first-in-first-out, last-in-first-out, etc.)

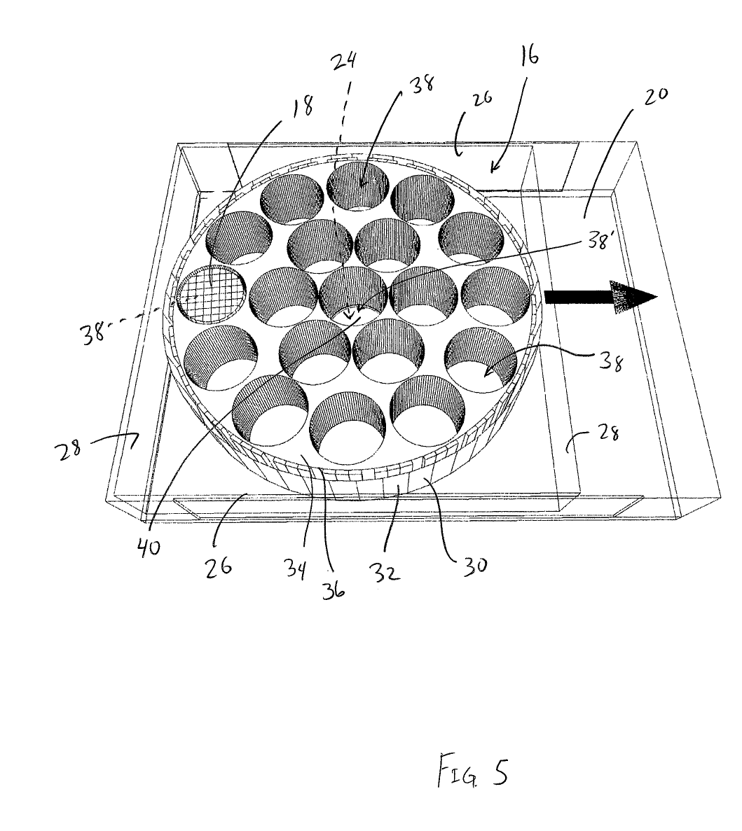

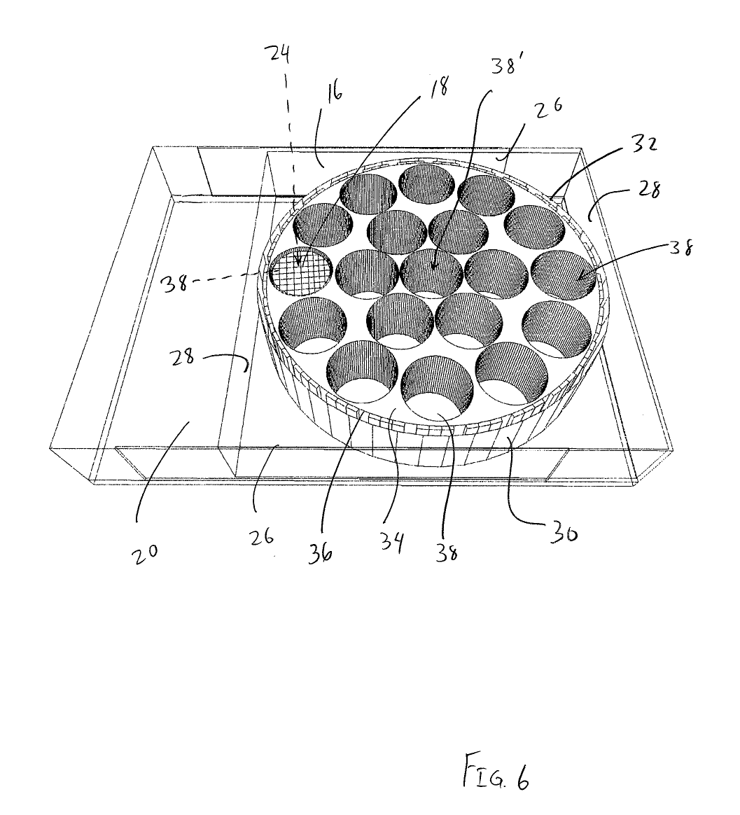

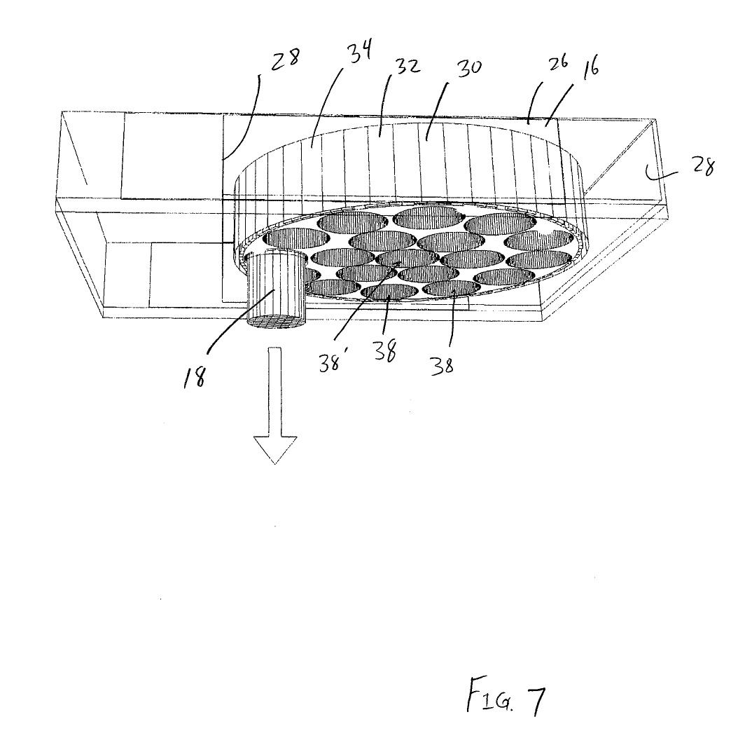

Once the item 18 to be retrieved, and its associated compartment 38, are identified (shown as item 18 in FIG. 4), the guide 34 is rotated until the item 18/compartment 38 is laterally aligned with the opening 24, as shown in FIG. 5. By “laterally aligned” it is meant that the item 18/compartment 38 is aligned with the opening 24 in the direction of lateral movement of the drawer 16. Next, the drawer 16 is laterally moved until the desired compartment 38/item 18 is positioned over the opening 24, as shown in FIG. 6. Once the item 18 is positioned over the opening 24, the shutter 40 is opened, allowing the item 18 to pass through the opening 24 in the separator plate 20, thereby falling by gravity to the slot 22/drawer 16 positioned below, as shown in FIG. 7. Of course, this order of operation can be reversed, and the drawer 16 can first be moved laterally prior to rotation of the guide 34, or lateral movement of the drawer 16 can take place simultaneously with rotation of the guide 34.

At the same time that the drawer 16 containing the item 18 is moved/manipulated, or in any case before opening the shutter 40, each of the drawers 16 below the item 18 are laterally moved by the controller 42 such that their central openings 38′, or some other open compartment 38, is aligned with the openings 24 of their separator plates 20, thereby forming a transfer duct 26 of aligned openings 38 and/or center compartments 38′ through which the item 18 can freely pass. Alternately, if desired and mechanically feasible, the lower drawers 16/guides 34 can be simply moved entirely out of the way such that they completely unobstruct the associated, lower-positioned openings 24, thereby allowing the item 18 to pass through the aligned openings 24.

Once access is provided to the openings 24 and the transfer duct 26 is formed, and the shutter 40 below the item 18 to be retrieved is opened, the item 18 falls by gravity through the aligned openings 38, 38′/transfer duct 26, and then exits to a handling system 46 for further processing. A cushion or the like may be positioned at the bottom of the cabinet 12/transfer duct 26 to provide shock absorption and protect the falling item 18. In the embodiment shown in FIG. 1, the handling system 46 includes a tube or pipe 48 communicating with the transfer duct 26. Once the item 18 is extracted from the cabinet 12 and enters the handling system 46, the item 18 can be further automatically processed, such as through a variety of conveyors and conveyor systems, pneumatic systems, diverters, etc.

After the item 18 has exited the cabinet 12, the drawers 16/guides 34 may be moved to a rest position in which they are optimally positioned and configured for rapid retrieval or placement of the greatest number of items 18, or positioned for rapid retrieval/placement of the most commonly extracted or placed item, or the item which is predicted to be next extracted/placed. Alternately, the drawers 16/guides 34 may simply reside in their previous positions without any further movement or adjustment.

As the retrieved item 18 is processed through the handling systems 46, computers or the like, in conjunction with various types of sensors or scanners (such as optical sensors, weight sensors, magnetic sensors, or the like), may be utilized to track the item 18 as it moves through the handling system 46. Moreover, scanners or the like may be used to read coded machine-readable labels on the items 18 to provide feedback to ensure that the item 18 is correctly and automatically routed to the desired destination. The handling system 46 can incorporate diverters to urge the items 18 off of a conveyor at the appropriate location. The diverters can take the form of push levers or arms, pop-up wheels, individual tiltable trays or the like using systems such as programmable logic control (“PLC”) systems. In addition, the cabinets 12/controller 42 may be integrated into, and controlled by, the PLC system, or the controller 42 may be part of the PLC system.

If desired the system 10 may include a pneumatic assist feature which provides positive and/or negative pressure to the aligned openings 38, 38′/transfer duct 26/pipes 48 to aid in transportation of the items 18. For example, in the illustrated embodiment, a suction source may be applied to the tube 48 positioned at the bottom of the cabinet 12 to aid in downward extraction of the item 18. In this case, then, the shutters 40 may be slotted or otherwise have openings 52 or be permeable to transmit differences in air pressure thereacross, even when they are closed. Other motive sources or item movement assist features, such as magnetic or otherwise, may also be utilized. Alternately or in addition, as shown in FIG. 1, the cabinet 12 may include a tube or the like 48 at the top end of the cabinet 12 through which items 18 can exit upwardly for further handling. In this case, the direction of airflow can be reversed as desired to move the items 18 in the desired direction. Additionally, if desired an auger, elevator, lift or the like may be positioned internally or on the side of the cabinet 12 to elevate articles to the top for re-stocking the cabinet 12.

Of course, the system and process described above can also be utilized in reverse to stock items and refill the storage cabinet 12. In particular, in the illustrated embodiment, incoming items 18 are fed through either of the top or bottom tubes 48 or other input system. The drawers 16 and guides 34 are shifted to their desired position and alignment until the appropriate compartment 38 of the designated drawer 16 and guide 34 are aligned with the transfer duct 26, and the appropriate shutter 40 is closed. The item 18 then passes through the aligned opening(s) 38, 24, enters the desired compartment 38 (bottoming out on an underlying (or upper) shutter 40, depending upon the direction of flow) and is securely received therein for later retrieval as desired. In addition, if desired, items 18 can be moved within the cabinet 12 to move an item 18 from one drawer 16/guide 34 to another. Items 18 can also be moved from one compartment 38 to another, or from one cabinet 12 to another, for optimal storage and positioning.

The cabinet 12 can be configured in a variety of differing configurations. For example, rather than having a single opening 24 in each separator plate 20, each separator plate 20 may include multiple openings 24. This configuration can reduce the average amount of movement required by the guide 34 to bring the desired compartment 38/item 18 in alignment with an opening 24 and reduces response time. Furthermore, rather than having vertically-aligned openings 24 forming a vertically aligned transfer duct 26, the transfer duct 26 may be formed at angle relative to the vertical. In this case, then each compartment 38 may not necessarily be vertically aligned and instead may be skewed. For example, rather than taking the form of a right cylinder, each compartment 38 may take the form of an oblique cylinder. In this case, the angled compartments 38 and transfer duct 26 provide some friction to items sliding therethrough and slow the rate of “falling” of the items. Further alternately, if desired, the cabinet 12 of FIG. 1 can be turned on its side such that the compartments 38 and transfer duct 26 extend generally horizontally. In this case, some sort of movement assist feature may be required for placement of items into, and removal from, the cabinet 12.

The items 18 can be arranged in the guides 34/drawers 16/cabinet 12 to ensure the most efficient storage and dispensing. For example, high volume items can be stored in the top and/or bottom guides 34/drawers 16, closest to the exit of the cabinet 12. In addition, high volume items can be stored in the more central compartments 38 of a particular guide 34/drawer 16. In this manner, movement of the guides 34 is minimized when providing access to the high volume items, which reduces the time required to access and store items 18, and reduces wear and tear of the cabinet 12.

Thus, as can be seen, each guide 34/drawer 16 and/or opening 24 may be configured such that any compartment 38 can be positioned over the opening 24, including the radially outer-most compartments 38 of the guide 34. In one embodiment, then, the guide 34/drawer 16 has a lateral range of motion relative to the opening 24/separator plate 20 of at least about the radius of the guide 34. By providing direct access to each compartment 38/item 18, the cabinet 12, and system 10 as a whole, thereby provides rapid, accurate random access to a large number of items 18 for improved access and storage. Thus it can be seen that the system 10 disclosed herein provides quick, convenient and accurate retrieval and storage of items 18. The system 10 minimizes carrying costs and errors while maximizing throughput and reducing or eliminating manual labor. The cabinet 12 and system 10 described herein therefore eliminate the need to manually handle items 18 and provides the ability to track the flow of items 18.

The system 10 described herein may be utilized to automate storage and dispensing of relatively small items 18, which can typically comprise 60-70% of the number of articles of inventory, depending, of course, upon the particular user. In particular, the system 10 may be configured to store and deliver items 18 weighing about less than ten pounds and/or less than about ten inches long, although, again, the system 10 can be modified for other use as desired. The cabinet 12 may include an information panel coupled thereto which provides information about the contents of the cabinet 12. In particular, in one embodiment the display panel may be a dynamic or interactive display panel operatively coupled to the controller 42 which electronically displays the identity of the items 18, and their count, inside that cabinet 12.

The cabinet 12 can be entirely enclosed by the panels 14a, 14b, 14c, 14d, 14e, which provides increased security and reduces shrinkage and lost items. In addition, if desired, the cabinet 12 can be sealed and pressurized by injection of compressed air or other gases. In this manner, the cabinet 12 is pre-pressurized throughout its inner volume and provides a reserve of pressurized air that can be applied to an item 18 which is desired to be rapidly extracted from the cabinet 12. The introduction of pressurized air into the cabinet 12 also helps to supply forced air along the path of the items 18 as they are transported along the handling system 46. This, in turn, may make it possible to operate the system 10 without the use of compressors or pipes, or aids compressors to apply conveyance forces during peak load times. The system 10 may also be sealed to prevent contamination of the items stored therein, and also allow the system to be refrigerated to store perishables or other items desired to be stored at low (or elevated) temperatures. The cabinet 12 may also be used as a stand alone items for dispensing items, such as a vending machine or the like.

The cabinet 12 and parts thereof shown in FIGS. 1-8 can be part of a larger automated storage and dispensing system. In particular, as shown in FIG. 9 multiple cabinets 12 can be operatively coupled together and/or operatively coupled to the handling system 46. Each cabinet 12 may also be operatively coupled to excess storage bins 50 which store items 18 but are not necessarily dispensing cabinets 12 in the manner disclosed herein. For example, each excess storage bin 50 may be dedicated to storing a particular item 18, and be operatively coupled to the materials handing system 46. In this manner, when a cabinet 12 is running low on a particular item, the cabinet 12 can be automatically replenished by receiving inventory from an excess storage bin 50. The replenishment can be carried out automatically by the controller 42, or overseen or approved by a supervisory individual. In this manner, large amounts of inventory can be automatically stored and dispensed.

The controller 42 can also be configured to receive and fill orders for multiple, aggregated items 18 in the form of a shipment, quality inspection request, inventory auditing request or the like. For example the controller 42 may receive a request for an order or command which consists of a number of various items 18. The request may identify the items 18, or alternately, the controller 42 may have stored in its memory, or have access to memory, which identifies which particular items 18 are included in the order or command. The controller 42 then oversees retrieval of the items 18 the cabinet 12 or cabinets 12. The retrieved items 18 may then be automatically sent to a common area, via the handling system 46, for automatic or manual processing, such as by placing all of the retrieved items 18 in a container such as a plastic bag, cardboard box, shrink wrap, secured to a pallet, etc. In this manner, all of the items 18 for an order or command can be retrieved simultaneously, or near-simultaneously, resulting in rapid processing. Additionally, a quality control review or inventory audit can be done manually or automatically with the use of various sensors, such as optical sensors utilizing a comparator image, a magnetometer, a scale, etc. Items retrieved from the system can be re-introduced into the cabinet 12 upon a completion of the quality control review or inventory audit.

Having described the invention in detail and by reference to certain embodiments, it will be apparent that modifications and variations thereof are possible without departing from the scope of the invention.

What is claimed is:

1. A storage and dispensing system comprising a cabinet including:
a frame having a plurality of separators, each separator including an opening formed therethrough; and
a plurality of drawers, each drawer having a plurality of compartments configured to store an item therein, wherein each drawer is positioned adjacent to at least one of said separators and is movable relative to the adjacent separator such that each compartment of each drawer is positionable adjacent to the opening of the associated separator.

2. The system of claim 1 wherein each compartment of each drawer is rotatable and laterally movable relative to the opening of the associated separator.

3. The system of claim 1 wherein each drawer includes a guide which includes said compartments, and wherein each guide is rotatable relative to the associated separator, and wherein each drawer is laterally displaceable relative to the associated separator.

4. The system of claim 1 wherein at least one drawer is positioned between a pair of said separators.

5. The system of claim 1 further comprising a plurality of items, each item being received in one of said compartments.

6. The system of claim 5 wherein each item is closely received in an associated compartment.

7. The system of claim 5 wherein each drawer and separator is generally horizontally aligned, and wherein each item rests upon an associated, underlying separator.

8. The system of claim 1 wherein said opening is about the same size as a cross section of one of said compartments.

9. The system of claim 1 wherein each drawer to one side of an item of interest is positioned such that an empty compartment thereof is aligned with an associated opening to allow said item of interest to pass through said aligned openings and compartments.

10. The system of claim 1 further comprising a plurality of retractable shutters, each shutter being positioned adjacent to an associated opening, wherein each shutter is movable between a closed position wherein the shutter generally blocks the associated opening to generally prevent items from passing therethrough, and an open position wherein the shutter generally does not block the associated opening to allow items to pass therethrough.

11. The system of claim 1 further comprising a controller operatively coupled to each drawer to control the movement of each compartment relative to the opening of the associated separator.

12. The system of claim 11 wherein said controller is configured to receive an input representing a request for a particular item, identify a drawer and a particular compartment of said identified drawer which stores said particular item, and provide an output which causes said identified drawer to be manipulated such that the particular item is first positioned adjacent to the opening of the associated separator and then passes through the opening of the associated separator.

13. The system of claim 1 wherein each separator is generally flat and planar, and wherein each drawer is laterally displaceable along a plane positioned parallel to a plane of an associated separator.

14. The system of claim 1 further comprising a motive source operatively connectable to a compartment aligned with an opening of one of said separators to aid in introducing, relocating or evacuating items stored in said compartments from said cabinet.

15. The system of claim 14 wherein said motive source is a gravity, a suction source, or a high pressure source, or a hydraulic source, or a magnetic field source.

16. The system of claim 1 wherein said cabinet is generally sealed to allow pressurization or temperature control thereof.

17. A storage and dispensing system comprising a cabinet including:
a frame;
a plurality of drawers, each drawer including a base portion and a guide which includes a plurality of compartments configured to receive an item therein, wherein each guide is rotatable relative to the associated base portion, and wherein each drawer is laterally displaceable relative to the frame; and
a controller operatively coupled to each drawer to control the rotation of each guide and the lateral displacement of each drawer such that each compartment can be positioned to allow an item to be removed therefrom or received therein.

18. A method for storage and dispensing items comprising:
accessing a cabinet including a frame and plurality of separators, each separator including an opening formed therethrough, the cabinet further including a plurality of drawers, each drawer having a plurality of compartments for storing an item therein, wherein each drawer is positioned adjacent to at least one of said separators;
causing a drawer to be moved relative to the adjacent separator such that a compartment of said moved drawer is positioned adjacent to the opening of the adjacent separator; and
causing an item to be passed through the opening of the adjacent separator such that the item is placed into, or retracted out of, an associated compartment.

19. The method of claim 18 wherein said first causing step includes rotating and laterally moving the associated compartment relative to the associated separator.

20. The method of claim 18 further comprising the step of, prior to the first causing step, a controller receiving a request for a particular item, in response to which the controller causes the drawer to be moved as specified in said first causing step.
